(19) United States
(12) Patent Application Publication
(10) Pub. No.: US 2023/0098715 A1
(43) Pub. Date: Mar. 30, 2023

(54) Shape-Shifting Tread Unit

(71) Applicant: Southwest Research Institute, San Antonio, TX (US)

(72) Inventors: Cody Bressler, San Antonio, TX (US); Meera M. Towler, San Antonio, TX (US)

(73) Assignee: Southwest Research Institute, San Antonio, TX (US)

(21) Appl. No.: 17/490,672

(22) Filed: Sep. 30, 2021

(51) Int. Cl. B62D 55/065; B62D 55/30

(52) U.S. Cl. CPC B62D 55/065; B62D 55/30

(57) ABSTRACT

An autonomous self-driving assembly that includes a shape-shifting tread unit. The tread unit is utilized the support the mobility of the assembly while also of a shape-shifting capacity to brace the assembly in a narrow space of a confined area. In this manner, a load-based application may be performed with the assembly in a stable and reliable manner. Once more, the shape-shifting tread unit includes jacking mechanisms to support the raising of the vertical profile of the unit to attain the bracing. At the same time, tensioners are used to cooperatively shorten the vertical profile so as to maintain a predetermined range of tension on the treads of the unit during the shape shifting.

### BACKGROUND

Over the years, industrial applications ranging from servicing wells, exploring natural underground formations and caves, or even inspection of large man-made structures are increasingly performed by autonomous assemblies. For example, in the circumstance of well servicing, a tractor-like assembly may be used to advance imaging or interventional equipment into a well for inspection or for performing a more invasive application at a predetermined location. This is understandable given that manually accessing such a location, is not directly possible. Further, in many instances, simply dropping a vertical slickline cable or other type of conveyance line with application tools might be impractical. For example, the well may not remain vertical but rather take on a tortuous architecture or even become horizontal. Thus, traversing tortuous stretches or accessing horizontal legs is not possible without some sort of actively motive assembly. In other circumstances, things may be complicated by changing well diameter or the introduction of certain hardware obstructions.

While tractoring provides an example of an autonomous assembly effective for a consistently narrow passageway, it is not an effective mode of conveyance when the passageway fails to remain of a fairly consistent profile. This is because tractoring generally involves the use of separate units that intermittently anchor to the well wall or casing. In this way, the “tractor” may be advanced by pulling in an inchworm like fashion. This also means that these units require contacting the wall defining the passageway at opposing locations simultaneously. However, this is only possible in a passageway where these expandable units may be sized in light of a known fairly consistent diameter. If the passageway is of inconsistent or dramatically varying dimensions such as a room of a cave, ship hull or other facility with perhaps a connecting narrow passage, the ability to tractor ceases. This is because, once the tractor traverses the narrow passage and reaches a large room, the ability to anchor in the room is lost because the tractor arms are not able to simultaneously reach opposing walls of the room. Therefore, the ability to move is also lost.

A different way to access confined areas with both narrow passages and larger chambers or rooms is to utilize assemblies with treads. An autonomous self-driving assembly may utilize one or more tread units to move throughout such areas. Indeed, the assembly may be configured to accommodate an application tool to perform an application anywhere in the confined area. In such cases, it is not uncommon for the tread unit(s) to be the largest profile component of the assembly. Thus, as long as each tread unit is small enough to navigate narrow passages of the confined area with some degree of clearance, the assembly may be able to reach all regions of the confined area for inspection or to perform various applications.

While a tread unit is advantageous for advancing the assembly in either narrow passages or larger rooms, there remains some disadvantages when it comes to performing applications with the assembly. For example, when the assembly is of a tractor variety instead of utilizing treads, it has the advantage of the noted anchoring or bracing when in narrower passages as described above. This could be helpful where an application of some force is to be performed in such a passage. That is, the anchoring nature of the tractor is such that it may naturally brace against opposing passage wall locations to stabilize the assembly for the application. Indeed, whether the tool of the autonomous assembly supports drilling, water jetting, power washing or any number of applications likely to involve hundreds of pounds of force or more, the braced assembly within a narrow passage may be more than stable enough to effectively carry out the application.

Unfortunately, where the autonomous self-driving assembly is a conventional tread driven assembly, the opportunity to anchor within the narrow passage is unavailable. Indeed, some degree of clearance is even necessary in order for the assembly to move through the passage. Once more, even if an expansion of the tread unit were possible to eliminate the clearance and brace the assembly within the passage, this would subject the actual tread to a dramatic rise in tension. This could potentially damage the tread, leaving the entire assembly stuck in the passage. Thus, as a practical matter bracing or anchoring of a tread driven assembly is generally unavailable.

Given the above state of affairs, operators are generally left with the option of utilizing tread assemblies for passive applications such as imaging while more interventional applications that deliver force may only be carried out by tractoring assemblies within appropriately narrow passages. This means that operators are left the inefficiency of utilizing one type of autonomous assembly in a narrow passage that must be removed and replaced with another type in order to reach any more sizable enclosure.

### SUMMARY

An autonomous, self-driving assembly is disclosed. The assembly includes at least one tread unit for advancement and stability in a confined space. The unit consists of a tread about rollers to effect the advancement and maintain a predetermined range of tension. A jacking mechanism is provided along a first axis of the unit to govern a profile of the tread along the axis. Further, a tensioner is provided along a second axis of the unit to govern a profile of the tread along the second axis. The profiles cooperatively ensure the maintenance of the predetermined range of tension for the tread.

### BRIEF DESCRIPTION OF THE DRAWINGS

FIG. 1A is a side perspective view of an embodiment of an autonomous self-driving assembly in the form of a shape shifting tread unit in a first lowered profile.

FIG. 1B is a side perspective view of the shape shifting tread unit of FIG. 1A in a second raised profile.

FIG. 2 is a side perspective view of the shape shifting tread unit of FIGS. 1A and 1B in a narrow passage of a confined area.

FIG. 3A is a side view of the shape shifting tread unit of FIG. 2 in the narrow passage and located at an application position with the tread unit in the first lowered profile.

FIG. 3B is a side view of the shape shifting tread unit of FIG. 3A in the narrow passage with the tread unit raised to the second raised profile for bracing.

FIG. 3C is a side view of the shape shifting tread unit of FIG. 3B braced in the narrow passage to perform a load-based application.

FIG. 4 is a perspective view of an alternate embodiment of an autonomous self-driving assembly utilizing multiple shape shifting tread units.

FIG. 5 is a flow-chart summarizing an embodiment of utilizing an autonomous self-driving assembly in the form of a shape shifting tread unit to perform a load-based application in a confined area.

### DETAILED DESCRIPTION

In the following description, numerous details are set forth to provide an understanding of the present disclosure. However, it will be understood by those skilled in the art that the embodiments described may be practiced without these particular details. Further, numerous variations or modifications may be employed which remain contemplated by the embodiments as specifically described.

Embodiments are described with reference to certain facility applications where direct human intervention is not practical or desirable such as in the hull of a nuclear submarine. Of course, such confined areas with narrow spaces may include locations outside of ship hulls, such as liquid transport carriers, wind turbines, nuclear facilities, manmade facilities in war zones or even natural cavernous areas. In the particular example illustrated herein, a load-based drilling or milling application within a narrow passageway is illustrated. In the illustrative scenario, an autonomous self-driving assembly in the form of a shape shifting tread unit is directed in a narrow passage to near the void location, braced or anchored by a raised profile and a drilling application is carried out to reach the void. Thus, a resin, insulation or other material may be backfilled into the void. The scenario, however, is but one of potentially countless different ones that might take advantage of an autonomous self-driving assembly with shape shifting tread units. Pressure washing, media blasting, or any number of other load-based applications may be facilitated by such an assembly. Indeed, so long as the assembly is navigable through a narrow passageway while also being capable of changing the tread unit profile for anchoring or bracing to support a load-based application therein, appreciable benefit may be realized.

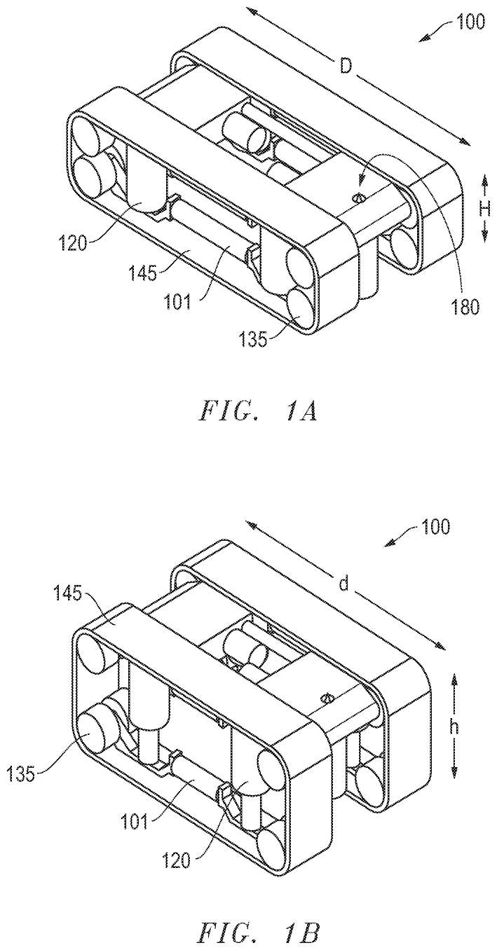

Referring now to FIG. 1A, a side perspective view of an embodiment of an autonomous self-driving assembly in the form of a shape shifting tread unit 100 is shown. The unit 100 is an advance mobility crawler that accommodates an application tool 180. In the embodiment shown, the tool 180 is an extendable drill. However, the tool 180 may be any number of different devices configured to facilitate an application with the potential to involve some measure of load or force (for example, in excess of 10 lbs. of force).

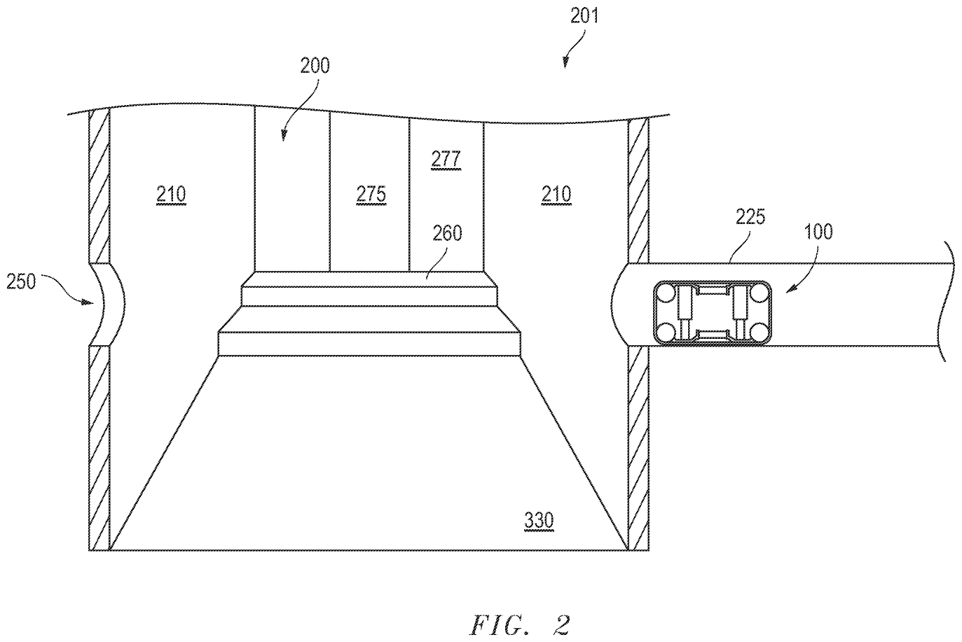

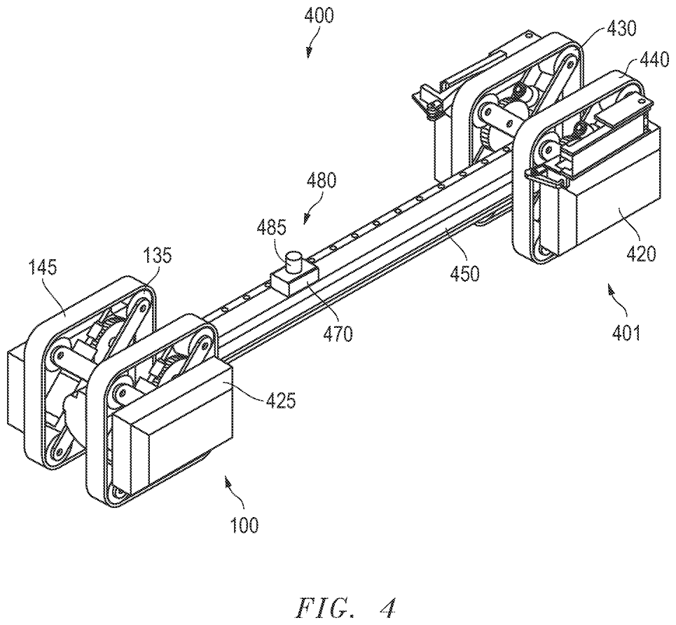

In the view of FIG. 1A, the unit 100 is in a first lowered profile with a limited height (H), perhaps 2-6 inches. The interior of the unit 100 is visible, though a covering 420 or 425 may be added to shield internal components (see FIG. 4). Rollers 135 are clearly visible about which a tread 145 may move for advancement of the unit 100. However, more notably, vertically oriented jacking mechanisms 120 are shown in a fully retracted position resulting in the depicted height (H). The jack mechanisms 120 may be conventional actuators that drive two parallel sides of the treads 145. In the retracted, lowered profile position, the unit 100 may be well suited for squeezing through a narrow passageway 225 as described below (see FIG. 2).

With the unit 100 in a lowered profile and height (H), the treads 145 are also of an extended horizontal distance (D) across the top and bottom of the unit 100 about the rollers 135. The distance (D) may be between about 6 and 12 inches. A tensioner 101 may be used to maintain this distance (D) and hold a predetermined amount of tension on the treads 145. For example, in one embodiment, the treads 145 may have between about 75 and 125 lbs. of tension.

Referring now to FIG. 1B, a side perspective view of the tread unit 100 of FIG. 1A is shown in a second raised profile. Specifically, the jacking mechanisms 120 have been raised such that a second larger height (h) is reached. By the same token, the treads 145 are not particularly expandable. Thus, in order to accommodate the larger height (h), the horizontal distance of the treads is reduced to a second shorter distance (d). This is done in a manner governed by the tensioner 101 which compresses to allow the reduction in horizontal tread distance (d). Nevertheless, the tensioner 101 also works to maintain the predetermined tension on the treads 145. Thus, in the present example, between 75 and 125 lbs. of tension is maintained on the treads 145. The same would be true in a circumstance where the unit 100 shape shifted back to the lower profile of FIG. 1A.

It is worth noting that the terms “vertical” or “horizontal” are not meant to infer that the jacking mechanisms 120 or the tensioners 101 are precisely vertical or horizontal. These terms are also not meant to infer that mechanism 120 or tensioner 101 axes are perpendicular to one another. Rather, the terms are only meant to infer that the axes are different and intersecting in some angular manner and would not be, for example, parallel.

Referring now to FIG. 2, a side perspective view of the shape shifting tread unit 100 of FIGS. 1A and 1B is depicted in a narrow passageway 225 of a confined area 201. The confined area 201 includes both narrow spaces such as the passageway 225 (and a window 250) and wide spaces (e.g. 200) such as a ship hull, a nuclear submarine, a facility in a war zone or even a natural cavernous area. Of course, the environment may lack the larger wide space 200 such as a narrow passage of a large wind turbine or an aircraft wing.

Regardless of the particular type of confined area 201, the shape shifting tread unit 100 of FIG. 2 is configured for movement through both types of spaces 225 and 200. With added reference to FIGS. 1A and 1B, the shape shifting unit 100 takes on the low profile within the passageway 225 as shown in FIG. 1A. However, upon reaching the floor 230 of the larger wide space 200 of a chamber or room, the unit 100 may take on the raised profile of FIG. 1B. For example, this may be advantageous for the unit 100 upon encountering potential obstructions such as stairs 260 leading to a vertical passage 275. Indeed, the unit 100 may be better able to partially climb walls 210, 277 when in the raised profile of FIG. 1B. Of course, the larger raised profile may be utilized within the passageway 225 to brace the unit 100 to perform a load-based application.

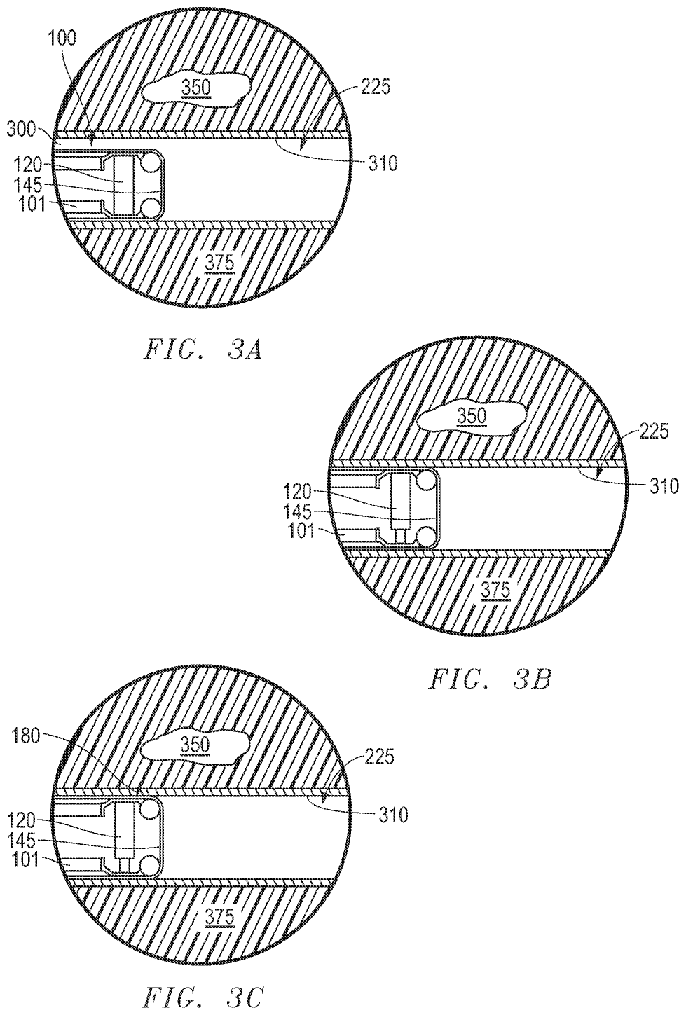

Referring now to FIG. 3A, a side view of the shape shifting tread unit 100 of FIG. 2 is shown in the narrow passageway 225 and located at an application position and in the first lowered profile (e.g. of FIG. 1A). In this position, there is adequate clearance 300 to allow the unit 100 to reach the application position. In the example scenario, the application position is within the passageway 225 adjacent a void 350 in an otherwise material 375 filled location defining the passageway 225. The void 350 may be an accidental void in insulation, structural resin or other material with the unit 100 brought into position for accessing and potentially filling the void 350.

With specific reference now to FIG. 3B and added reference to FIG. 1B, a side view of the unit 100 of FIG. 3A in the narrow passage 225 is illustrated with the unit 100 raised to the second raised profile for bracing. Notice the raised jacking mechanism 120. At the same time, the distance (d) of the horizontal portions of the treads 145 are reduced while maintaining consistent tension due to the tensioner 101. With the unit 100 braced in position, the tool 180 of FIGS. 1A and 1B is located below the void 350. Thus, a drilling application may be undertaken as illustrated in FIG. 3C (see the extending drill 380 of the tool 180).

Ultimately, a channel may be drilled through the material 375 to reach the void 350. Another unit or self-driving assembly for delivering resin, insulation or other injectable material to the void 350 may subsequently be driven into position or the unit 100 itself may also include such a tool and/or be connected to a line reaching an external location for hydraulic material delivery. Whatever the case, the unit 100 is maintained firmly in place by the described shape shifting and jacking mechanism support. Thus, even where the unit 100 is fairly narrow, small and lightweight, it remains stable regardless of any process reaction loads due to the drilling or other applications.

In the embodiment of FIGS. 3A-3C, the application at hand is a drilling application that may subject the assembly 100 to a force of up to 100 lbs. Of course, any number of applications may be carried out in this manner by such a unit 100. Power washing, milling, media blasting, backfilling or any number of other applications that might be considered “load-based” may be carried out by such a shape-shifting tread unit 100. As used herein, the term “load-based” is not meant to infer any particular amount of load or force but rather to highlight the fact that the application presents some non-negligible amount of load on the unit 100, unlike a visual inspection or data sensor-type application, for example. Although such passive, inspection-type applications may also be carried out by the unit 100. Once more, the types of confined areas are not limited to nuclear submarines, ships or even man-made structures. For example, the assembly 100 may be used to address issues within large wind turbines, aircraft wings, land-based nuclear facilities, man-made structures in war zones or even natural cavernous areas.

With added reference to FIG. 2, after performing the noted application(s), the unit 100 may leave the passageway 225 by shape shifting back into the lower profile depicted in FIG. 3A and move to the wider space 200 of the room depicted in FIG. 2. The unit 100 may move along the floor 230, traverse raised obstacles 260, and undertake other maneuvers.

In one embodiment, the tread 140 is equipped with a gripping enhancement as an aid to traversing an obstacle such as the depicted stairs 260. For example, magnetic or suction features may be employed to aid in climbing stairs 260 or even up a wall 210. However, as described below, the unit 100 may instead be part of a larger self-driving assembly 400 more tailored to performing such tasks (see FIG. 4).

Referring now to FIG. 4, a perspective view of an alternate embodiment of an autonomous self-driving assembly 400 is shown. In this embodiment, the assembly 400 includes multiple shape shifting tread units 100, 401. Indeed, the same unit 100 detailed above is included as part of the assembly 400 with the addition of a protective cover 425. In this embodiment, the assembly 400 is an advanced mobility crawler with a linear rail 450 running between the units 100, 401. The result is a gantry-like appearance with the rail 450 used to accommodate an application tool 480. In the embodiment shown, the tool 480 again includes an extendable drill 485 and a slidable base 470. However, as discussed, the tool 480 may be any number of different devices configured for directing an application with the potential to involve some measure of load or force (for example, in excess of 10 lbs. of force).

As indicated, the tool 480 is supported by a slidable base 470 as noted. Thus, the tool 480 may be located at any practical point along the rail 450 without requirement of moving the entire assembly 400. This may be advantageous in circumstances where the assembly 400 is immobile and braced by the units 100, 401 (e.g. in the passageway 225 of FIG. 2). Further, the rail 450 itself may be rotatable along an axis between the tread units 100, 401. So, for example, the drill 485 may be oriented downward or angled to one side and not just held in the upward position as shown.

With continued added reference to the environment of FIG. 2, the tread units 100, 401 may be in a pivotal relationship with the rail 450. Thus, upon leaving the passageway 225 and driving about the wide space 200, for example, as one unit 100 encounters the stairs 260, it may track upward, raising the rail 450 to an incline and angling the relationship or pitch between the rail 450 and each unit 100, 401.

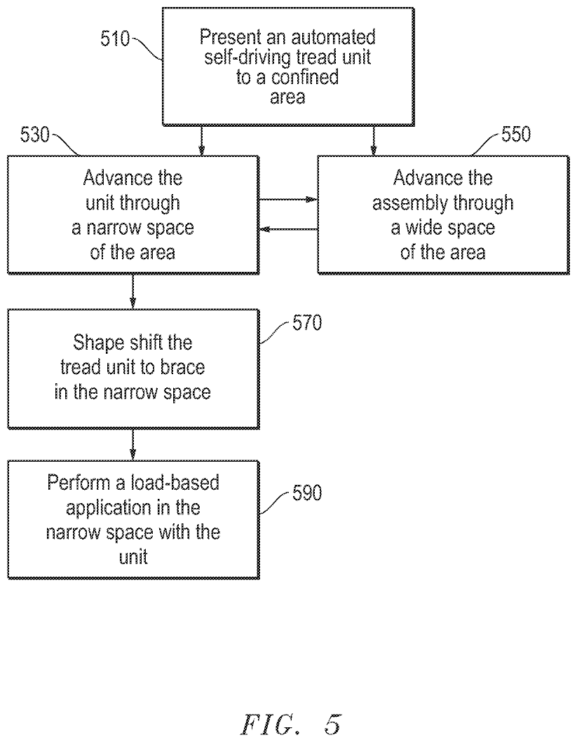

Referring now to FIG. 5, a flow-chart is shown summarizing an embodiment of a shape shifting tread unit to perform a load-based application in a confined area. As indicated at 510, the challenge of a confined area is presented to an automated self-driving unit. The unit is configured for advancement through narrow spaces 530 and wide spaces 550. The unit is also uniquely configured for shape shift bracing within such narrow spaces 550 to support a load-based application therein 590.

The preceding description has been presented with reference to presently preferred embodiments. Persons skilled in the art and technology to which these embodiments pertain will appreciate that alterations and changes in the described structures and methods of operation may be practiced without meaningfully departing from the principle and scope of these embodiments. Furthermore, the foregoing description should not be read as pertaining only to the precise structures described and shown in the accompanying drawings, but rather should be read as consistent with and as support for the following claims, which are to have their fullest and fairest scope.

We claim:

1. An autonomous self-driving assembly with a tread unit to support advancement and stability in a confined area, the tread unit comprising:
at least one tread to effect the advancement, the tread to maintain a predetermined range of tension;
a jacking mechanism along a first axis to govern a profile of the tread along the first axis; and
a tensioner along a second axis to govern a profile of the tread along the second axis, the profiles to cooperatively ensure the maintenance of the predetermined range of tension for the tread.

2. The autonomous self-driving assembly of claim 1 wherein the axes are non-parallel axes.

3. The autonomous self-driving assembly of claim 1 wherein the predetermined tension is between about 75 and about 125 lbs.

4. The autonomous self-driving assembly of claim 1 wherein the jacking mechanism is configured to raise the variable height to a raised profile for the unit to brace the unit in a narrow space of the confined area to perform an application therein with the autonomous self-driving assembly.

5. The autonomous self-driving assembly of claim 4 wherein the confined area is a structural facility further comprising at least one wide space.

6. The autonomous self-driving assembly of claim 4 wherein the narrow space is found within one of an aircraft wing, a wind turbine, a liquid transport carrier and a hull of a vessel.

7. The autonomous self-driving assembly of claim 1 wherein the tread unit is a first tread unit, the assembly further comprising:
a second tread unit;
a linear rail between and coupled to the units; and
an application tool coupled to the linear rail to perform a load-based application.

8. The autonomous self-driving assembly of claim 7 wherein the tool comprises a slidable base for positioning of the tool along the rail for the application.

9. The autonomous self-driving assembly of claim 8 wherein the tool further comprises an extendable drill.

10. A tread unit for an autonomous self-driving assembly to support advancement and stability in a confined area, the tread unit comprising:
at least one tread about rollers to effect the advancement, the tread to maintain a predetermined range of tension;
a jacking mechanism along a first axis to govern a variable height of the unit along a first axis; and
a tensioner along a second axis to govern a variable distance of the unit along the second axis, the height and the distance to cooperatively ensure the maintenance of the predetermined range of tension for the tread.

11. The tread unit of claim 10 wherein the jacking mechanism is configured to raise the variable height to a raised profile for the unit to brace the unit in a narrow space of the confined area to perform an application therein with the unit.

12. The tread unit of claim 10 wherein the jacking mechanism is configured to lower the variable height to a lowered profile for the unit to advance in a narrow space of a confined area.

13. A method of using an autonomous self-driving assembly in a confined area, the method comprising:
advancing the assembly through a narrow space of the area with a tread unit in a lowered profile;
shape shifting the tread unit from the lowered profile to a raised profile for bracing the assembly in the narrow space: and
performing a load-based application in the narrow space with the assembly.

14. The method of claim 13 wherein the tread unit comprises a tread with a predetermined range of tension about rollers, the shape shifting of the tread unit comprising:
employing at least one jacking mechanism of the tread unit to attain the raised profile, increasing a height of the tread;
employing at least one tensioner of the tread unit for cooperatively reducing a distance of the tread in light of the increasing of the height to maintain the predetermined range of tension in the tread during the shape shifting.

15. The method of claim 13 wherein the load-based application is selected from a group consisting of drilling, milling, backfilling, pressure washing, and media blasting.

16. The method of claim 13 wherein the tread unit is a first tread unit, the assembly further comprising a second tread unit with a linear rail coupled between the units, the performing of the load-base application further comprising:
positioning a base of an application tool along the rail; and
orienting the rail along an axis between the units to direct the tool at an application site in the narrow space.

17. The method of claim 13 wherein the shape shifting of the tread unit is within a narrow space of the confined area, the confined area further including a wide space.

18. The method of claim 17 further comprising performing a passive, non-load-bearing application with the assembly in one of the narrow space and the wide space.

19. The method of claim 17 further comprising:
shape shifting the tread unit from the raised profile to the lowered profile; and
using the tread unit to drive the assembly from the narrow space to the wide space.

20. The method of claim 18 further comprising shape shifting the tread unit from the lowered profile to the raised profile for encountering of obstructions in the wide space.
